(19) United States
(12) Patent Application Publication
(10) Pub. No.: US 2026/0229129 A1
(43) Pub. Date: Aug. 6, 2026

(54) OPERATION MANAGEMENT DEVICE

(71) Applicant: HITACHI, LTD., Tokyo (JP)

(72) Inventor: Nobuyasu KANEKAWA, Tokyo (JP)

(21) Appl. No.: 19/149,935

(22) PCT Filed: Dec. 21, 2023
(86) PCT No.: PCT/JP2023/045895

§ 371 Date: Jul. 22, 2025

(30) Foreign Application Priority Data
Jan. 31, 2023 (JP) 2023-013521

(51) Int. Cl. G08G 5/32

(52) U.S. Cl. CPC G08G 5/32

(57) ABSTRACT

The objective of the present invention is to provide an aircraft operation management device capable of efficiently determining flight paths across a plurality of managed airspaces. The operation management device performs operation management for aircraft flying across a plurality of managed airspaces, and manages the plurality of managed airspaces in an integrated manner. The operation management device sets a flight path determination difficulty level indicating the difficulty of determining a flight path within the managed airspace, for each managed airspace, and determines a flight path across the plurality of managed airspaces on the basis of the set flight path determination difficulty levels.

### TECHNICAL FIELD

The present invention relates to an operation management device of a flight vehicle.

### BACKGROUND ART

Flights beyond the visual contact of flight vehicles, including unmanned airplanes such as drones, are permitted and approved in the Japan's current aviation law on the condition of involving an assistant who manages third-party accesses, monitors the owned flight vehicle and manned airplanes, and monitors the weather around the owned flight vehicle, for example. In the future, there is a move to permit and approve flights beyond visual contact. For this purpose, at least the role of the assistant will require being replaced with a flight vehicle or ground facilities. There may be a critical need for operation management devices that enable flight vehicles to operate safely and efficiently. This type of operation management device or its functions are also referred to as UTM (Unmanned Aerial System Traffic Management). Patent Literature 1 is known as prior art for UTM.

### CITATION LIST

### Patent Literature

Patent Literature 1: Japanese Unexamined Patent Application Publication No. 2020-154762

### SUMMARY OF INVENTION

### Technical Problem

An operation management device settles the flight route of a flight vehicle within a management air area managed by itself so that the flight vehicle can fly safely and efficiently. When the number of flight vehicles increases and congests management air areas in the future, it is expected to be difficult for the operation management device to settle the flight route within the management air area. In particular, it is expected that the flight range of the flight vehicles widens and the flight route of a single flight vehicle crosses multiple management air areas managed by different management entities. The settlement of a flight route crossing multiple management air areas requires an enormous number of combinations of air areas to be treated as candidates for the flight route. Consequently, the operation management device explosively increases the amount of calculation to possibly cause a combinatorial explosion incapable of acquiring an optimal solution within a finite time, and degrade the performance of the operation management device.

The technology disclosed in Patent Literature 1 adjusts the flight plans of the flight vehicles belonging to different groups, but only assumes flights within the same management air area. The technology disclosed in Patent Literature 1 does not consider a flight plan of the flight vehicles flying across the multiple management air areas.

The present invention has been made in consideration of the foregoing. It is an object of the invention to provide an operation management device for flight vehicles capable of efficiently settling a flight route crossing multiple management air areas.

### Solution to Problem

To solve the above-described issue, an operation management device according to the present invention performs operation management on a flight vehicle flying the across multiple management air areas. The operation management device centrally manages the management air areas, assigns each of the management air areas with a flight route settlement difficulty indicating the difficulty of settling a flight route within the management air area, and settles a flight route across the management air areas based on the assigned flight route settlement difficulty.

### Advantageous Effects of Invention

The present invention can provide an operation management device for the flight vehicles capable of efficiently settling a flight route crossing multiple management air areas. Objects, configurations, and effects other than the above will be apparent from the description of the following embodiments.

### BRIEF DESCRIPTION OF DRAWINGS

FIG. 1 is a diagram illustrating an operation management device.

FIG. 2 is a diagram illustrating a functional configuration of the operation management device illustrated in FIG. 1.

FIG. 3 is a diagram illustrating a hardware configuration of the operation management device illustrated in FIG. 2.

FIG. 4 is a flowchart illustrating a process performed by the operation management device illustrated in FIG. 2.

FIG. 5 is a diagram illustrating a management air area.

FIG. 6 is a diagram illustrating the management air area.

FIG. 7 is a diagram illustrating the results of global flight route settlement for multiple management air areas illustrated in FIG. 5.

FIG. 8 is a diagram illustrating an example of dividing the management air area by using voxels.

FIG. 9 is a diagram illustrating a flight plan generated as a result of local flight route settlement for the management air area illustrated in FIG. 8.

FIG. 10 is a diagram illustrating an example of dividing the management air area by using corridors.

FIG. 11 is a diagram illustrating a flight plan generated as a result of the local flight route settlement for the management air area illustrated in FIG. 10.

FIG. 12 is a diagram illustrating flyable domain information.

FIG. 13 is a diagram illustrating the flight route settlement based on the flyable domain information.

FIG. 14 is a flowchart illustrating the algorithm of a process related to the flight route settlement.

FIG. 15 is a flowchart illustrating the algorithm of a process related to the flight route settlement.

FIG. 16 is a flowchart illustrating the algorithm of a process related to the flight route settlement.

FIG. 17 is a flowchart illustrating the algorithm of processes related to the local flight route determination illustrated in FIGS. 14 through 16.

FIG. 18 is a diagram illustrating penalties when the local flight route settlement fails.

FIG. 19 is a diagram illustrating the flight route settlement difficulties.

FIG. 20 is a diagram illustrating the global flight route settlement based on the flight route settlement difficulties illustrated in FIG. 19.

FIG. 21 is a diagram illustrating the global flight route settlement based on the flight route settlement difficulties illustrated in FIG. 19.

FIG. 22 is a diagram illustrating the flight route settlement difficulties.

FIG. 23 is a diagram illustrating an example in which the management air areas are not located closely.

### DESCRIPTION OF EMBODIMENTS

Hereinafter, one embodiment of the present invention will be described with reference to the accompanying drawings. Unless otherwise specified, configurations or functions designated by the same reference numerals in the embodiments have the same configurations or functions in the embodiments, and the description thereof will be omitted for brevity.

### First Embodiment

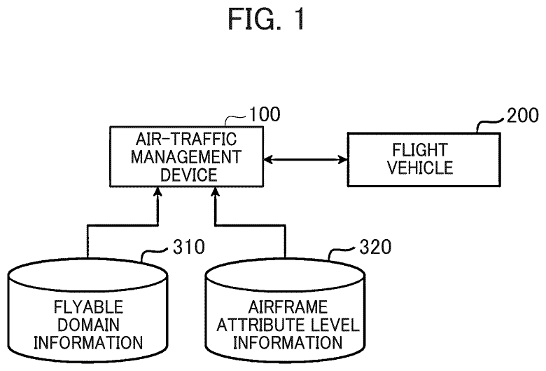

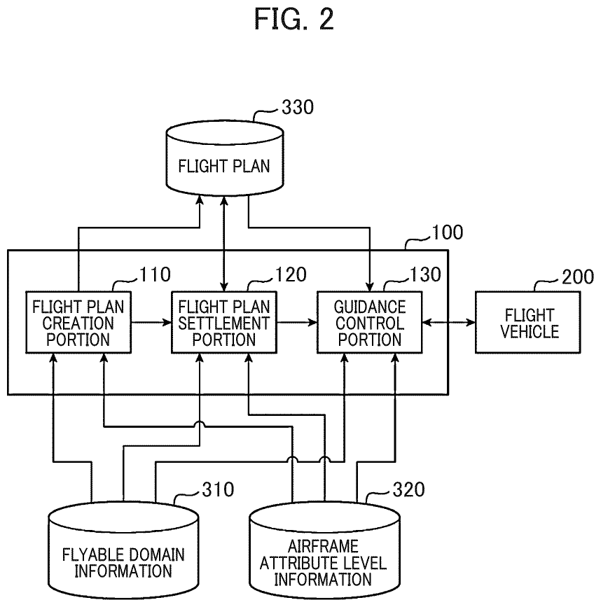

The first embodiment explains a basic embodiment of an operation management device. FIG. 1 is a diagram illustrating the operation management device. FIG. 2 is a diagram illustrating a functional configuration of the operation management device illustrated in FIG. 1.

The operation management device 100 performs operation management and flight control over a flight vehicle 200, including unmanned aerial vehicles such as a drones. The operation management device 100 may be a ground facility that configures a UTM. The operation management device 100 may also be referred to as a control device for the flight vehicle 200.

The operation management device 100 can perform operation management and the flight control over the flight vehicle 200 that flies across the multiple management air areas. The management air area is mainly managed by a service provider (UAS service supplier) as a management entity that performs the operation management and the flight control over the flight vehicle 200. Different management entities may manage at least part of the multiple management air areas where the flight vehicle 200 flies. According to the present embodiment, the operation management device 100 centrally manages the multiple management air areas.

The operation management device 100 performs the operation management and the flight control over the flight vehicle 200 based on flyable domain information 310 and airframe attribute level information 320. Specifically, the operation management device 100 generates a flight plan 330 for the flight vehicle 200 based on the flyable domain information 310 and the airframe attribute level information 320, finalizes (approves and registers) the generated flight plan 330, and provides control to guide the flight vehicle 200 so that it flies according to the flight routes. As illustrated in FIG. 2, the operation management device 100 includes a flight plan generation portion 110, a flight plan finalization portion 120, and a guidance control portion 130.

The flight plan generation portion 110 generates the flight plan 330 for the flight vehicle 200. The flight plan 330 includes at least a flight route from the departure place (also referred to as a starting point including the sky above) to the arrival place (also referred to as an arrival point including the sky above) of the flight vehicle 200 and a scheduled time of passage (including the scheduled times of departure and arrival) of the air area through which the flight route passes. The flight plan generation portion 110 settles the flight route and generates the flight plan 330 based on the flyable domain information 310 and the airframe attribute level information 320.

The airframe attribute level information 320 represents the attributes of the flight vehicle 200 on a level-by-level basis. The airframe attribute level information 320 includes flight continuity information representing the ability of the flight vehicle 200 to continue flying on the level-by-level basis. For example, the flight continuity information indicates the flight continuity capability of the flight vehicle 200 when the flight vehicle 200 malfunctions. The present embodiment uses three or more airframe attribute levels as the airframe attribute level information 320.

The flyable domain information 310 represents a domain (hereinafter also referred to as a “flyable domain”) enabling the flight vehicle 200 to fly within the management air area. The flyable domain information 310 is represented by a voxel (or corridor), the information as a unit air area for dividing the management air area. The flyable domain information 310 may include restriction level information that restricts the flight of the flight vehicle 200. The restriction level is used to set flight restriction domains, such as peripheries (including the sky above) around important facilities. The flyable domain information 310 is set for each airframe attribute level.

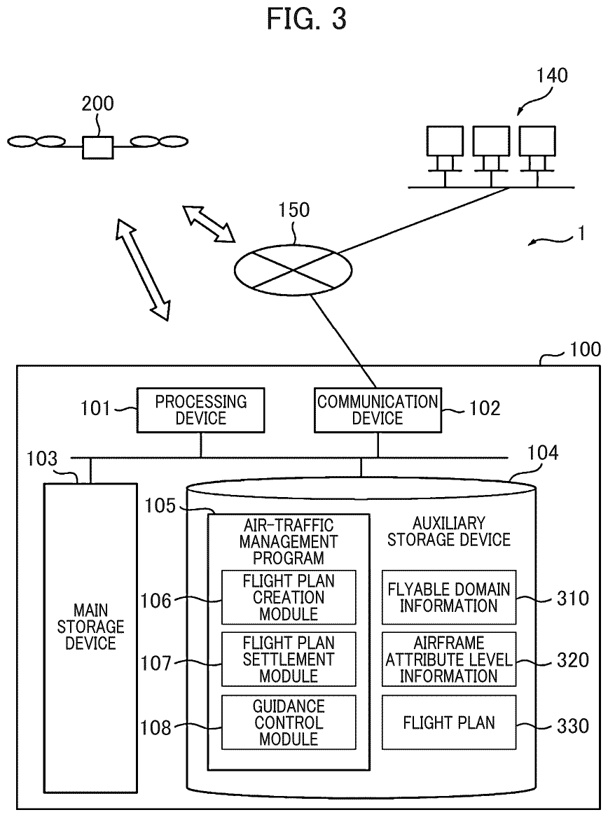

FIG. 3 is a diagram illustrating the hardware configuration of the operation management device illustrated in FIG. 2.

FIG. 3 illustrates the system configuration of an operation management system 1 including the operation management device 100. The operation management device 100 is connected to the flight vehicle 200 and a terminal device group 140 via a network 150. The operation management device 100 represents a computer, such as a server device in a cloud or local system. The operation management device 100 includes a processing device 101, a communication device 102, a main storage device 103, and an auxiliary storage device 104. These are mutually connected via communication paths.

The processing device 101 represents a processor such as a CPU (Central Processing Unit). The processing device 101 performs calculations according to an operation management program 105 stored in the auxiliary storage device 104.

The communication device 102 provides the interface function of the operation management device 100 with the outside. The communication device 102 receives input from users of the terminal device group 140 and transmits contents to be displayed on the terminal device group 140 via the network 150. The communication device 102 communicates with other operation management devices 100 managing other management air areas via the network 150.

The communication device 102 communicates with the flight vehicle 200 via the network 150 or directly. Specifically, the communication device 102 transmits control signals to the flight vehicle 200 to guide the flight of the flight vehicle 200 according to the calculations of the processing device 101. The communication device 102 receives information indicating flight situations (including the flight position, route, or attitude) from the flight vehicle 200.

The main storage device 103 is supplied with the operation management program 105 stored in the auxiliary storage device 104 and information used for calculations of the processing device 101. The auxiliary storage device 104 represents a so-called storage. The auxiliary storage device 104 is embodied as various storage media such as external HDD (Hard Disk Drive), SSD (Solid State Drive), or memory card. The auxiliary storage device 104 may represent a device such as a file server separate from the operation management device 100. The auxiliary storage device 104 stores the operation management program 105, the flyable domain information 310, the airframe attribute level information 320, and the flight plan 330. The auxiliary storage device 104 also stores other information, such as flight-related information and flight route settlement difficulty (to be described). The flyable domain information 310, the airframe attribute level information 320, and the flight plan 330 may be stored in a device other than the operation management device 100.

The operation management program 105 is modularized on a function basis and may be composed of a flight plan generation module 106, a flight plan finalization module 107, and a guidance control module 108. Each of these modules represents an individual program or a combination thereof. The operation management device 100 may represent multiple devices that are divided according to their functions.

The flight plan generation module 106, the flight plan finalization module 107, and the guidance control module 108 correspond to the flight plan generation portion 110, the flight plan finalization portion 120, and the guidance control portion 130 illustrated in FIG. 2, respectively. The processing device 101 can provide the functions of the flight plan generation portion 110, the flight plan finalization portion 120, and the guidance control portion 130 by executing the operation management program 105.

The terminal device group 140 represents a computer operated by a user. The terminal device group 140, according to the present embodiment, is composed of multiple terminal devices, but may be composed of a single terminal device.

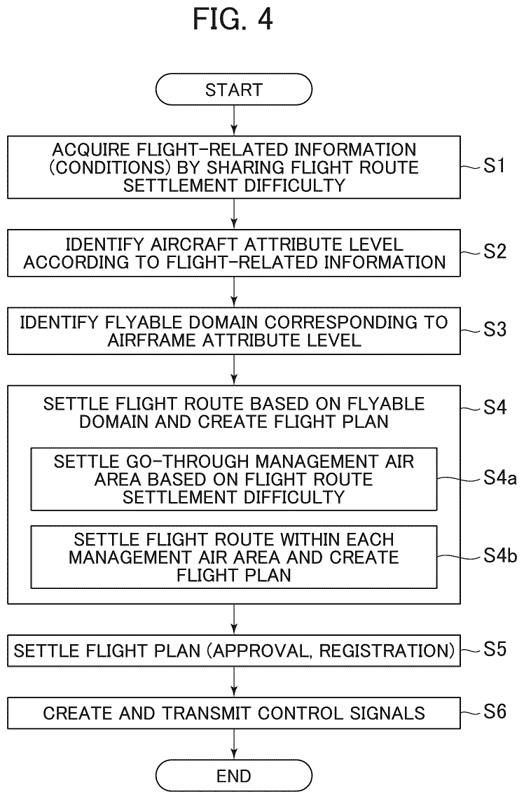

FIG. 4 is a flowchart illustrating the process performed by the operation management device illustrated in FIG. 2.

At Step S1, the operation management device 100 acquires the flight-related information about the flight vehicle 200. The flight-related information represents a prerequisite to generate the flight plan 330 for the flight vehicle 200. The flight-related information includes information about the flight vehicle 200, such as the departure place, scheduled departure time, arrival place, and scheduled arrival time. The flight-related information also includes the remaining amount of fuel or battery used for the flight vehicle 200, the weight of the flight vehicle 200, and meteorological information, for example. The operation management device 100 may acquire the flight-related information by receiving part of the flight-related information input by the user to the terminal device group 140 or by reading part of the previously stored flight-related information.

The operation management device 100 assigns each management air area with the flight route settlement difficulty (hereinafter also referred to as “difficulty”), indicating the difficulty of settling the flight route within the management air area. The flight route settlement difficulty will be described in detail later in an eighth embodiment.

At Step S2, the flight plan generation portion 110 of the operation management device 100 identifies an airframe attribute level corresponding to the flight-related information acquired at Step S1 by using the airframe attribute level information 320. Specifically, the flight plan generation portion 110 searches for the airframe attribute level information 320, including flight capabilities corresponding to the acquired flight-related information, and identifies the airframe attribute level indicated by the airframe attribute level information 320.

At Step S3, the flight plan generation portion 110 identifies a flyable domain corresponding to the airframe attribute level identified at Step S2 by using the flyable domain information 310. Specifically, the flight plan generation portion 110 identifies the location conditions of the voxels conforming to the identified airframe attribute level. The flight plan generation portion 110 identifies the restriction level of the voxels corresponding to the identified location condition by using the flyable domain information 310. The flight plan generation portion 110 extracts the voxels forming a flyable domain by considering the identified restriction level.

At Step S4, the flight plan generation portion 110 settles multiple management air areas (hereinafter also referred to as “go-through management air areas”) through which the flight vehicle 200 passes during the flight from the departure place to the arrival place, based on the flight route settlement difficulty of each management air area set at Step S1 (global flight route settlement at S4a). The flight plan generation portion 110 then settles the flight route within each management air area individually (local flight route settlement at S4b).

The local flight route settlement settles the flight route by combining flyable domains composed of the voxels extracted within each management air area settled in the global flight route settlement. Specifically, the flight plan generation portion 110 identifies the voxels that are extracted within each management air area and are continuous or adjacent from the departure place to the arrival place included in the flight-related information. The identified voxels are combined to configure a route that is identified as a flight route candidate. If there are multiple flight route candidates, the flight plan generation portion 110 evaluates these flight route candidates to settle the flight route. When evaluating the flight route candidates, the flight plan generation portion 110 can use an evaluation condition such as a short distance, a low restriction level, or a combination of these. The flight plan generation portion 110 can settle the flight route from the departure place to the arrival place, crossing multiple management air areas.

If there is no flight route candidate, the flight plan generation portion 110 outputs an infeasible flight to the communication device 102 and allows it to transmit this situation to the terminal device group 140. The flight plan generation portion 110 may output additional information prompting the user to create a flight plan to the communication device 102 and allows it to transmit the information to the terminal device group 140. The flight plan generation portion 110 thereafter terminates the process illustrated in FIG. 4.

When the flight route is settled, the flight plan generation portion 110 generates the flight plan 330 by performing a process such as adding identification information of the flight vehicle 200 and the scheduled time of passage to the voxels composing the settled flight route.

At Step S5, the flight plan finalization portion 120 of the operation management device 100 outputs the flight plan 330 generated at Step S4 to the communication device 102, and allows it to transmit the flight plan 330 to the terminal device group 140. The flight plan finalization portion 120 determines that the flight plan 330 is approved when the terminal device group 140 accepts the approval input from the user and the communication device 102 receives the approval input. The flight plan finalization portion 120 registers the approved flight plan 330 to the auxiliary storage device 104. The flight plan finalization portion 120 thereby finalizes the flight plan 330.

At Step S6, the guidance control portion 130 of the operation management device 100 generates a control signal corresponding to the flight plan 330 finalized at Step S5. The guidance control portion 130 outputs the generated control signal to the communication device 102 and allows it to transmit the control signal to the flight vehicle 200. The flight vehicle 200 will fly according to the finalized flight plan 330. At this time, the guidance control portion 130 outputs a control signal so that the flight vehicle 200 flies through each voxel at the scheduled time of passage included in the flight plan 330. The guidance control portion 130 thereafter terminates the process illustrated in FIG. 4.

In the process illustrated in FIG. 4, the operation management device 100 may allow the flight plan generation portion 110 to settle or generate multiple flight routes or multiple flight plans 330 and allow the flight plan finalization portion 120 or the guidance control portion 130 to select at least one of these flight routes or plans appropriate for the flight vehicle 200. When making this selection, the flight plan finalization portion 120 or the guidance control portion 130 may use the technique of evaluating flight route candidates described at Step S4. If the flight plan finalization portion 120 or the guidance control portion 130 cannot select at least one of these flight routes or plans appropriate for the flight vehicle 200, the flight plan generation portion 110 may settle or generate a new flight route or the flight plan 330. Alternatively, the flight plan generation portion 110 may settle or generate the flight route or the flight plan 330 each time the flight vehicle 200 flies.

As above, the operation management device 100 performs operation management on the flight vehicle 200 flying across the multiple management air areas. The operation management device 100 centrally manages multiple management air areas. The operation management device 100 assigns each management air area with the flight route settlement difficulty, indicating the difficulty of settling a flight route within the management air area. The operation management device 100 settles a flight route across the multiple management air areas based on the assigned flight route settlement difficulty.

The operation management device 100 can settle the flight route across the multiple management air areas by evaluating the difficulty in settling the flight route within each of the multiple management air areas based on the index common to the multiple management air areas. The operation management device 100 can accurately settle the management air area within which the flight route needs to be settled, thereby reducing the failure probability of the flight route settlement in the management air area. Consequently, the operation management device 100 can efficiently settle the flight route across the multiple management air areas.

Based on the flight route settlement difficulty, the operation management device 100 settles multiple management air areas through which the flight vehicle 200 flies from the departure place to the arrival place (global flight route settlement), and settles a flight route within each of the settled management air areas (local flight route settlement).

The operation management device 100 can thereby limit the management air areas in which the flight route is to be settled, before settling the flight route within the management air area, and therefore can limit the number of voxels or corridors to be calculated to settle the flight routes within the management air area. The operation management device 100 can reduce the number of combinations of the voxels or corridors treated as the flight route candidates within the management air area. It is possible to efficiently settle the flight route across the multiple management air areas without causing a combinatorial explosion.

### Second Embodiment

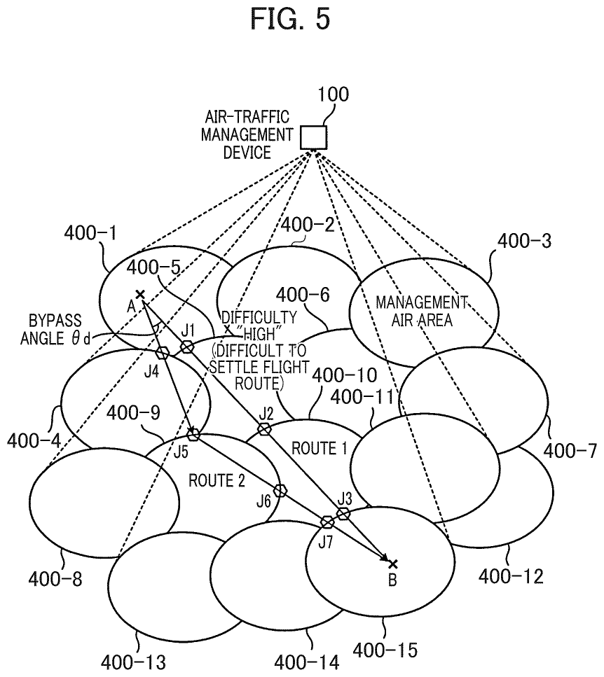

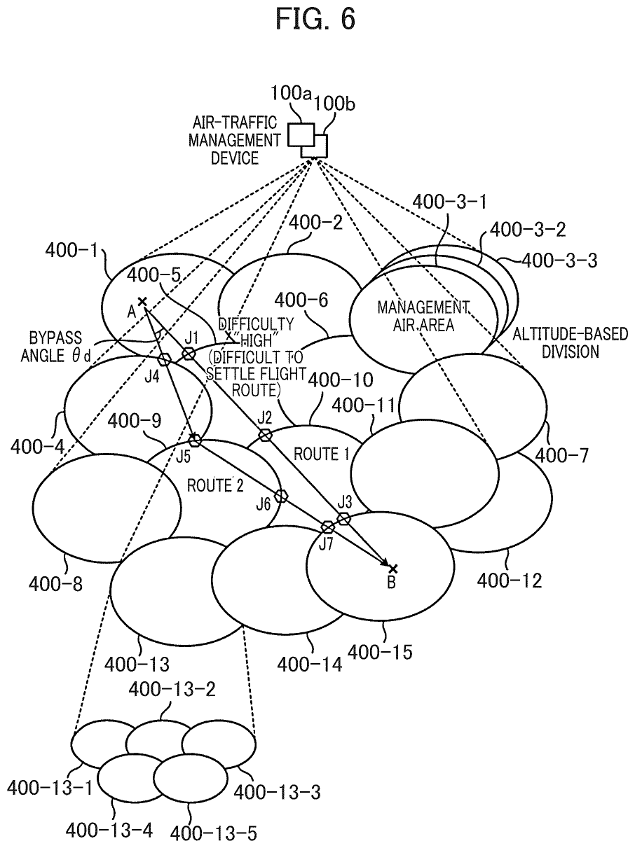

The second embodiment explains the management air area. FIG. 5 is a diagram illustrating the management air area. FIG. 6 is a diagram illustrating the management air area.

As illustrated in FIG. 5, the management air area is composed of multiple management air areas 400-1 through 400-n (where n denotes any natural number and n=15 in FIG. 5). One operation management device 100 centrally manages the multiple management air areas 400-1 through 400-n. The operation management device 100 calculates and sets a flight route settlement difficulty 300 for each of the management air areas 400-1 through 400-n. The operation management device 100 settles the flight route of the flight vehicle 200 based on the flight route settlement difficulty 300.

The method of settling the flight route of the flight vehicle 200 is to first settle multiple management air areas through which the flight vehicle 200 flies from the departure place to the arrival place (global flight route settlement). The method of settling the flight route of the flight vehicle 200 is then to settle the flight route within each go-through management air area (local flight route settlement).

A go-through management air area is settled based on the flight route settlement difficulty 300 during the global flight route settlement. In the example of FIG. 5, the shortest route (such as a straight route) from departure place A to arrival place B passes through the management air areas 400-1, 400-5, 400-10, and 400-15. The management air areas 400-1, 400-5, 400-10, and 400-15 overlap at connection points J1, J2, and J3, respectively. If this shortest route includes the management air area (management air area 400-5 in the example of FIG. 5), indicating the flight route settlement difficulty 300 greater than or equal to the standard, the go-through management air areas are settled by avoiding such management air area. In the example of FIG. 5, the management air areas 400-1, 400-4, 400-9, 400-10, and 400-15 are settled as the go-through management air areas. The management air areas 400-1, 400-4, 400-9, 400-10, and 400-15 overlap at connection points J4, J5, J6, and J7, respectively. There may be multiple candidates to settle the go-through management air areas by bypassing the management air area, indicating the flight route settlement difficulty 300 greater than or equal to the standard. Then, a bypass route indicating a small bypass angle θd or a short route length is selected preferentially.

The management air areas 400-1 through 400-n are set up to a certain height based on ground coordinates. As illustrated in FIG. 6, one management air area 400-3 may be divided into separate management air areas 400-3-1 through 400-3-m (where m denotes any natural number and m=3 in FIG. 6) on an altitude basis. The operation management device 100 may manage the management air areas 400-3-1 through 400-3-m. Alternatively, as illustrated in FIG. 6, operation management devices 100a and 100b, as multiple ground facilities constituting one UTM, may manage the management air areas 400-3-1 through 400-3-m.

As illustrated in FIG. 6, one management air area 400-13 may be further divided into smaller management air areas 400-13-1 through 400-13-k (where k denotes any natural number and k=5 in FIG. 6).

### Third Embodiment

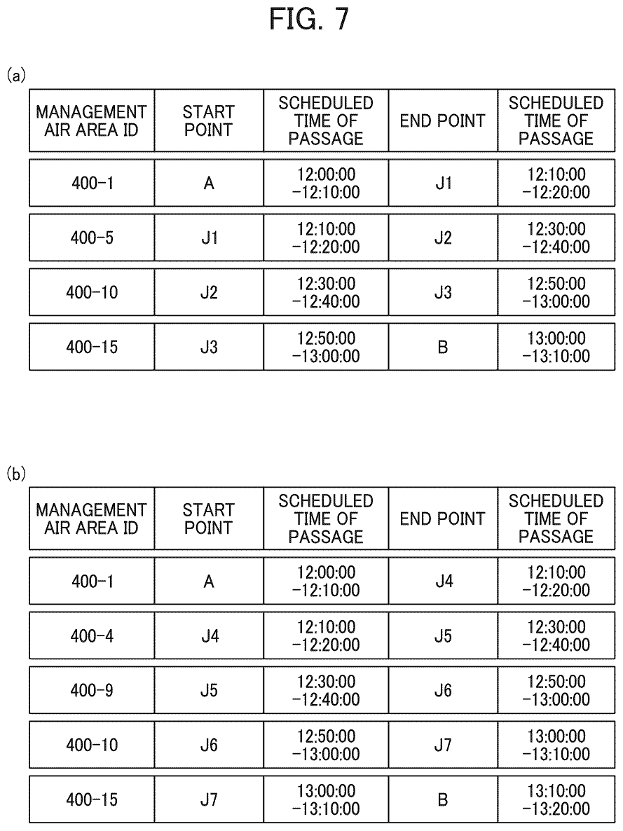

The third embodiment explains the results of the global flight route settlement. FIG. 7 is a diagram illustrating the results of the global flight route settlement for the multiple management air areas illustrated in FIG. 5.

The result of the global flight route settlement is represented as a combination of go-through management air areas. As illustrated in FIG. 7, the result of the global flight route settlement is represented as a combination of the ID of the go-through management air area, the coordinates and the scheduled time of passage at the start point within the management air area, and the coordinates and the scheduled time of passage at the end point within the management air area. FIG. 7 (a) illustrates the shortest route from the departure place A to the arrival place B acquired as a result of the global flight route settlement. FIG. 7 (b) illustrates the bypass route from the departure place A to the arrival place B acquired as a result of the global flight route settlement.

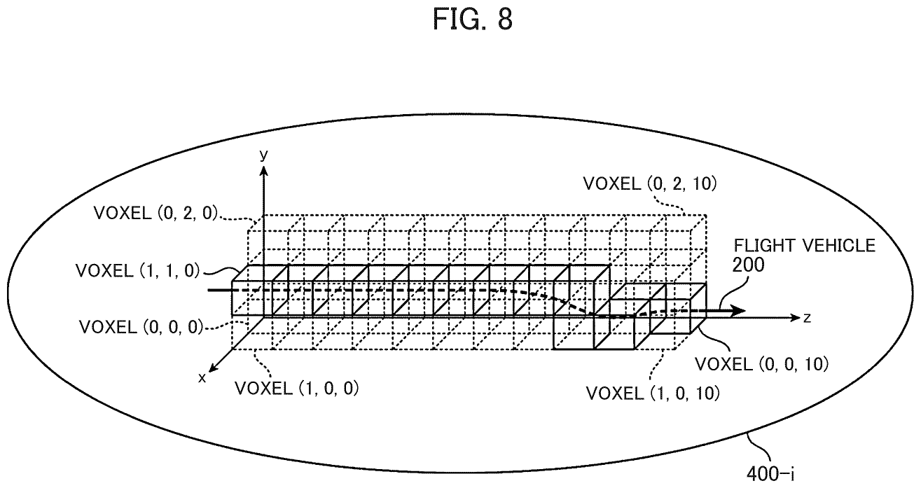

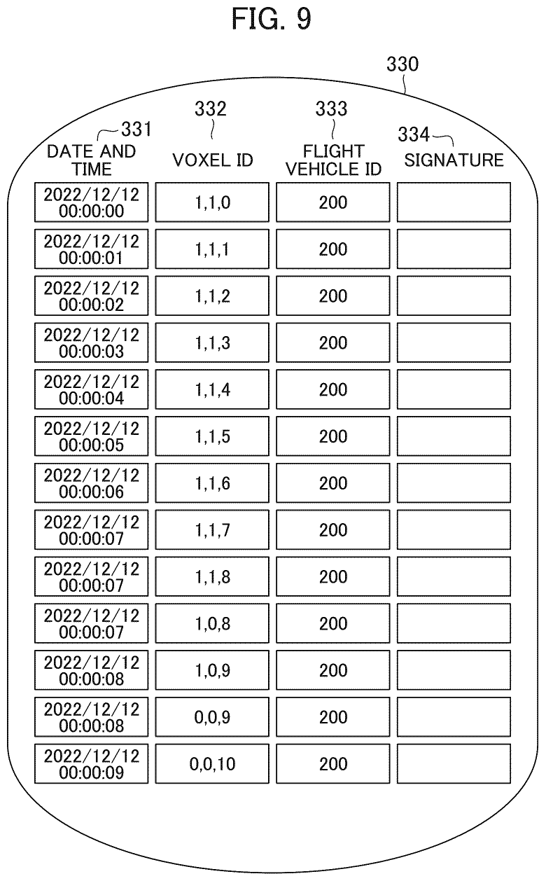

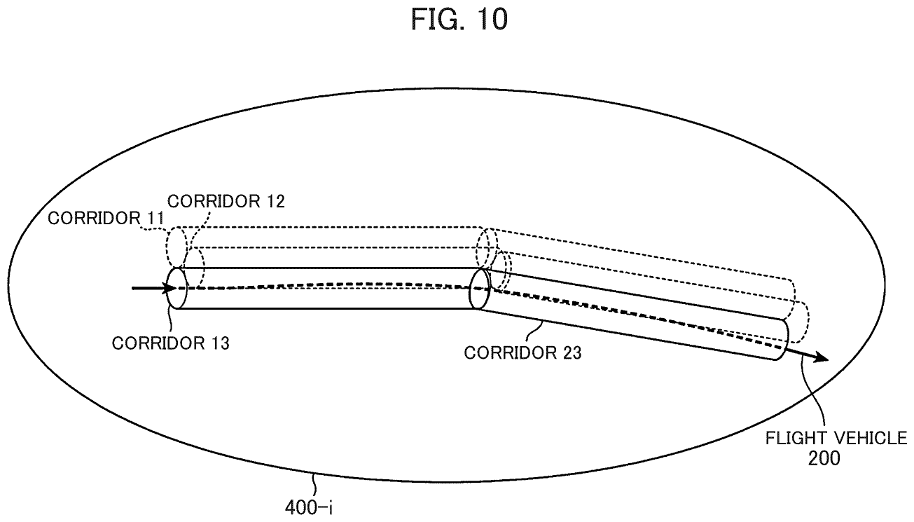

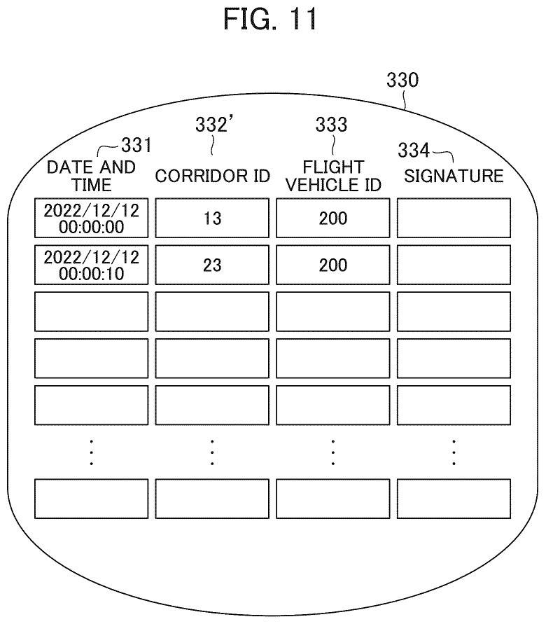

FIG. 7 (a) illustrates that the route passes through the management air areas 400-1, 400-5, 400-10, and 400-15. FIG. 7(a) illustrates the departure place A, connection points J1, J2, and J3, and the arrival place B represented as start and end points in the corresponding management air areas, in addition to the scheduled time of passage corresponding to each start point and end point. The connection points are represented by voxel IDs as illustrated in FIGS. 8 and 9, or corridor IDs as illustrated in FIGS. 10 and 11.

FIG. 7 (b) illustrates that the route passes through the management air areas 400-1, 400-4, 400-9, 400-10, and 400-15. FIG. 7 (b) illustrates the departure place A, the connection points J4, J5, J6, and J7, and the arrival place B represented as start and end points in the corresponding management air areas, in addition to the scheduled time of passage corresponding to each start point and end point.

### Fourth Embodiment

The fourth embodiment explains the results of the local flight route settlement. FIG. 8 is a diagram illustrating an example of dividing the management air area by using the voxels. FIG. 9 illustrates a flight plan generated as the result of the local flight route settlement on the management air area illustrated in FIG. 8.

As illustrated in FIG. 8, management air area 400-i (where i denotes any natural number and 1≤i≥n) represents one of the multiple management air areas 400-1 through 400-n and is divided into multiple voxels. The flight route within management air area 400-i may be represented as a set of voxels the flight vehicle 200 occupies at the corresponding time. In this case, the flight plan 330 in management air area 400-i is also expressed as a set of voxels occupied by the flight vehicle 200 at the corresponding time, as illustrated in FIG. 9. Specifically, the flight plan 330 is represented as a set of a date and time 331, a voxel ID 332, a flight vehicle ID 333, and an authentication signature 334. The flight plan shows that flight vehicle ID 333 occupies the voxel ID 332 at date and time 331. The voxel ID is expressed as the (X, Y, Z) coordinates of a voxel.

The examples in FIGS. 8 and 9 show that the flight vehicle 200 occupies voxels (1, 1, 0), (1, 1, 1), (1, 1, 2), (1, 1, 3), (1, 1, 4), (1, 1, 5), (1, 1, 6), (1, 1, 7), (1, 1, 8), (1, 0, 8), (1, 0, 9), (0, 0, 9), and (0, 0, 10) as time advances from 00:00:00 on Dec. 12, 2022 to 00:00:09 on Dec. 12, 2022.At 00:00:07 on Dec. 12, 2022, the flight vehicle 200 occupies three adjacent voxels (1, 1, 7), (1, 1, 8), and (1, 0, 8). Similarly, at 00:00:08 on Dec. 12, 2022, the flight vehicle 200 occupies two adjacent voxels (1, 0, 9) and (0, 0, 9).

To avoid collisions between the flight vehicles 200, the flight vehicle 200 needs to exclusively occupy voxels in terms of space and time. Namely, the date and time 331 and the voxel ID 332 need to be assigned to each flight vehicle 200 without overlaps. The flight plan generation portion 110 settles the flight route within the management air area 400-i and generates the flight plan 330 so that the date and time 331 and the voxel ID 332 are not assigned to multiple flight vehicle IDs 333 duplicately.

The flight plan finalization portion 120 confirms that the date and time 331 and the voxel ID 332 are not duplicated (not assigned to multiple flight vehicle IDs 333) each time the flight plan 330 is generated or updated, and writes the authentication signature 334 as evidence of the confirmation. The authentication signature 334 may use a predetermined code. Alternatively, the authentication signature 334 may use a sum check on information such as the date and time 331, the voxel ID 332, and the flight vehicle ID 333, or a calculated value of a predetermined polynomial based on the information. It is possible to determine whether the flight plan 330 is valid by determining whether the authentication signature 334 matches an expected authentication value supplied from the information, such as the date and time 331, the voxel ID 332, and the flight vehicle ID 333.

The guidance control portion 130 controls and guides the flight vehicle 200 based on the flight plan 330. Specifically, the guidance control portion 130 supplies a control signal to the flight vehicle 200 according to the date and time 331, the voxel ID 332, and the flight vehicle ID 333 included in the flight plan 330. If the flight of the flight vehicle 200 is likely to deviate from the flight plan 330, the flight vehicle 200 is supplied with a control signal to correct its flight.

### Fifth Embodiment

The fifth embodiment explains the division of a management air area by using corridors. FIG. 10 is a diagram illustrating an example of dividing the management air area by using corridors. FIG. 11 is a diagram illustrating the flight plan generated as a result of the local flight route settlement on the management air area illustrated in FIG. 10.

The management air area 400-i may be divided into multiple corridors as illustrated in FIG. 10. The flight route within the management air area 400-i can be represented as a set of corridors occupied by the flight vehicle 200 at the corresponding time. In this case, the flight plan 330 in management air area 400-i is also expressed as a set of corridors occupied by the flight vehicle 200 at the corresponding time, as illustrated in FIG. 11. Specifically, the flight plan 330 is represented as a set of the date and time 331, corridor ID 332′, the flight vehicle ID 333, and the authentication signature 334. The flight plan shows that the flight vehicle ID 333 occupies the corridor ID 332′ at the date and time 331.

The examples of FIG. 10 and FIG. 11 show that the flight vehicle 200 occupies a corridor 13 at 00:00:00 on Dec. 12, 2022, and the corridor 23 at 00:00:10 on Dec. 12, 2022. Similar to the fourth embodiment, the flight plan generation portion 110 and the flight plan finalization portion 120 generate and finalize the flight plan 330. Similar to the fourth embodiment, the guidance control portion 130 guides and controls the flight vehicle 200.

It is also possible to represent air areas near airports or flight route branching points by the voxels as illustrated in FIG. 8, and represent a route connecting them by using corridors as illustrated in FIG. 10. In this case, it may be favorable to share the field for the voxel ID 332 and the corridor ID 332′ and add an identifier to identify whether the ID indicates a voxel or a corridor. For example, the field for voxel ID 332 is prefixed with identifier “V,” and the field for the corridor ID 332′ is prefixed with identifier “C.”

### Sixth Embodiment

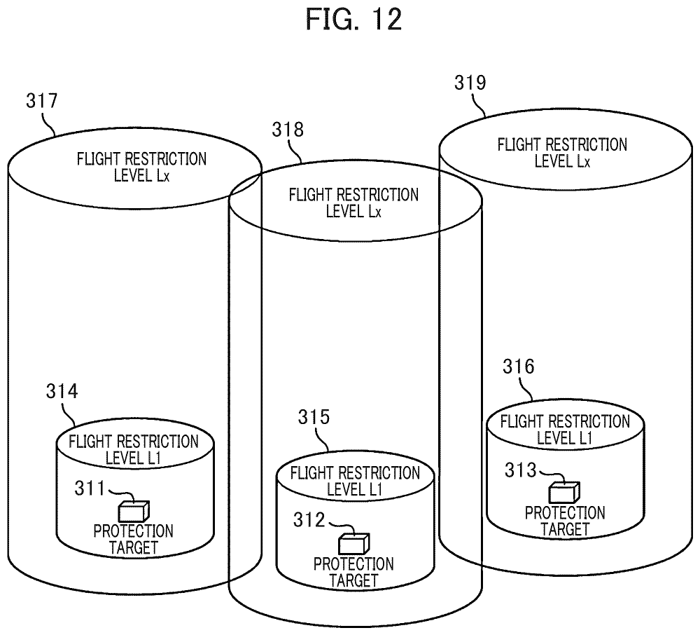

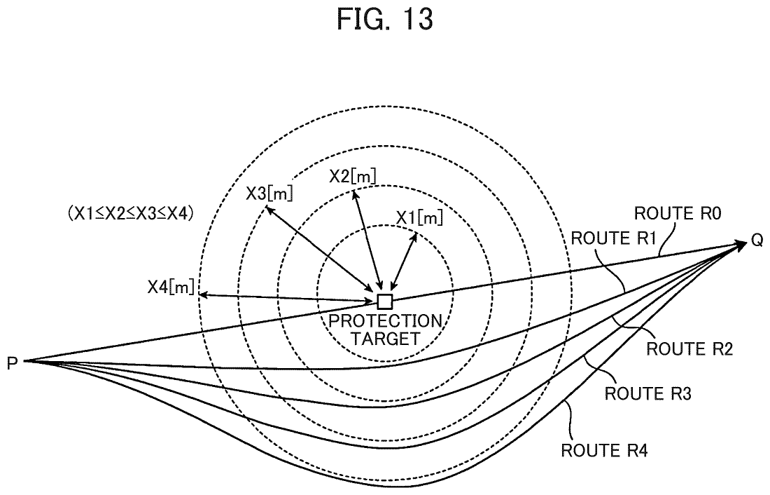

The sixth embodiment explains the flyable domain information. FIG. 12 is a diagram explaining the flyable domain information. FIG. 13 is a diagram illustrating the flight route settlement based on the flyable domain information.

The flyable domain information 310 represents the flyable domain by using the coordinates of a unit air area (voxel or corridor) or the unit air area ID (voxel ID or corridor ID) on the air area map of the management air area. The flyable domain information 310 according to the present embodiment includes the coordinates of protection targets 311, 312, and 313 such as important facilities, and the coordinates of level-L1 flight restriction domains 314, 315, and 316, and level-Lx flight restriction domains 317, 318, and 319 corresponding to the protection targets 311, 312, and 313, respectively.

In the above-described example, the flyable domain information 310 previously specifies the flight restriction domains on the air area map. Meanwhile, the flyable domain information 310 may include the coordinates of the protection targets on the air area map and information on the restriction levels to restrict the flight of the flight vehicle 200. The flight plan generation portion 110 may specify the restriction domains (coordinates) corresponding to the restriction levels based on the flyable domain information 310.

FIG. 13 shows an example of settling flight routes based on the flyable domain information 310. The flight route from point P to point Q in the management air area must be separated from the protection target on the route by a predetermined distance (X1 through X4 [m], where X1<X2<X3<X4) according to the attributes (such as airframe attribute levels) of the flight vehicle 200. Therefore, the flight routes from point P to point Q are settled as route R4, route R3, route R2, and route R1 in ascending order of the airframe attribute levels of the flight vehicle 200. The flight vehicle 200 satisfying a higher airframe attribute level can fly a shorter flight route from point P to point Q. Route RO to fly over an important facility (including flights for maintenance and inspection of the important facility), settled as the flight route, is limited to the flight vehicle 200 that ensures an extremely high airframe attribute level, low failure rate, and high security level.

### Seventh Embodiment

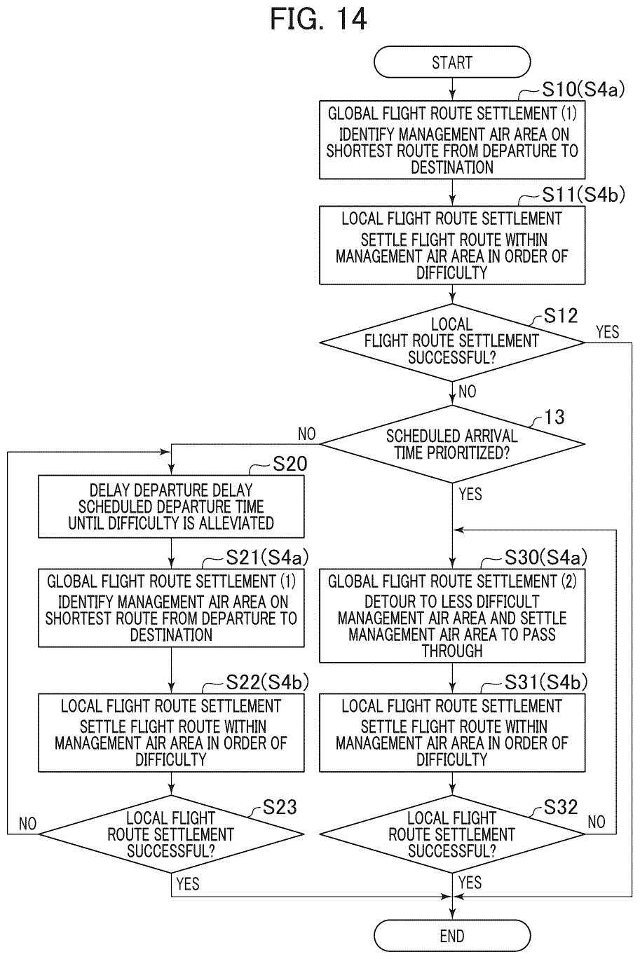

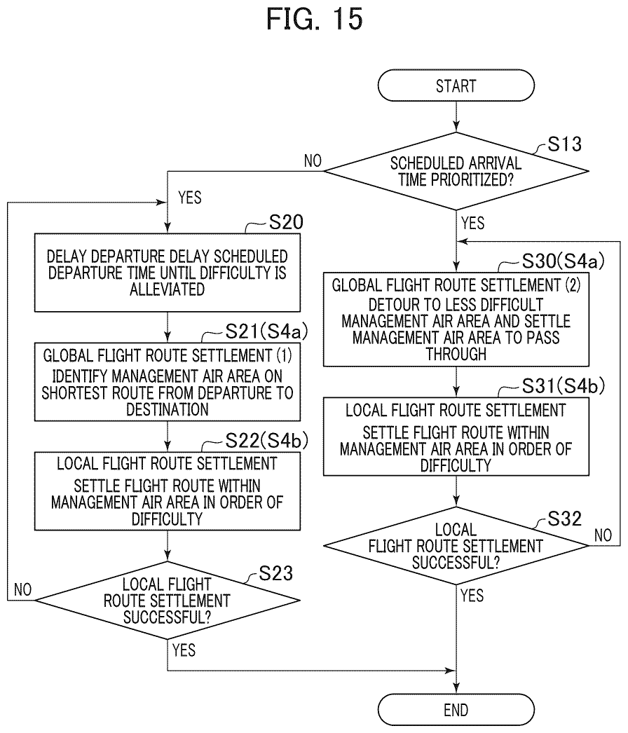

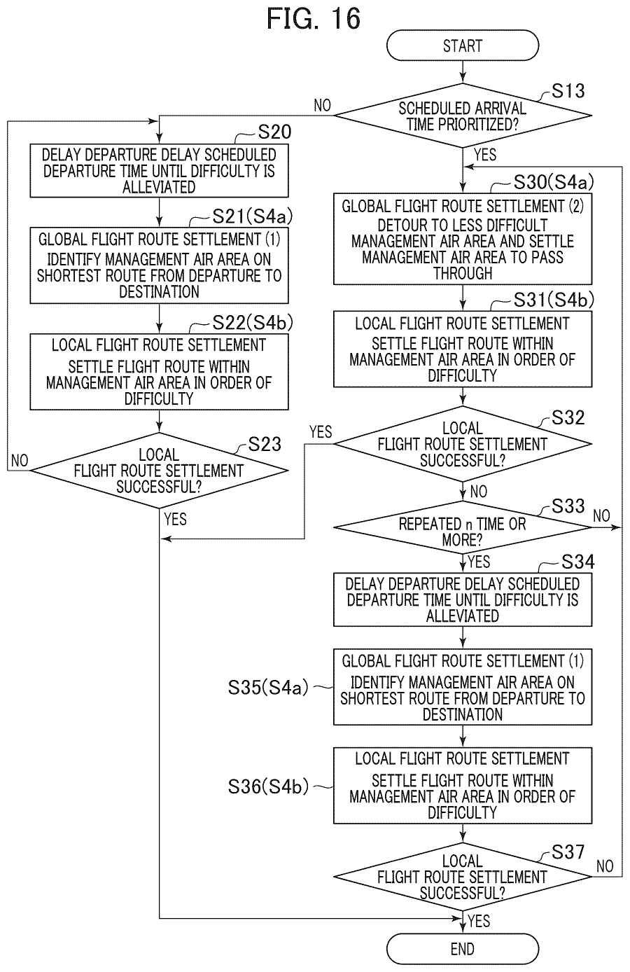

The seventh embodiment explains processes related to the flight route settlement. FIG. 14 is a flowchart illustrating an algorithm of processes related to the flight route settlement. FIG. 15 is a flowchart illustrating the algorithm of processes related to the flight route settlement. FIG. 16 is a flowchart illustrating the algorithm of processes related to the flight route settlement.

The flowcharts illustrated in FIGS. 14 through 16 are performed at Step S4 of FIG. 4.

At Step S10, the flight plan generation portion 110 performs the global flight route settlement (1) to settle multiple management air areas through which the flight vehicle 200 passes when flying the shortest route (such as a straight route) from the departure place to the arrival place.

At Step S11, the flight plan generation portion 110 performs the local flight route settlement to settle the flight route within the management air area in descending order of the flight route settlement difficulties of the management air areas settled at Step S10. For example, suppose the flight route settlement difficulties include “low” difficulty capable of settling the flight route within the management air area as the shortest route, “medium” difficulty capable of settling the flight route within the management air area as the bypass route, not the shortest route, and “high” difficulty incapable of settling the flight route within the management air area even as the bypass route. Suppose the management air areas settled at Step S10 are assigned the “low” or “medium” flight route settlement difficulty. In this case, the flight plan generation portion 110 settles the flight routes within the management air areas in the order of the “medium” flight route settlement difficulty and the “low” flight route settlement difficulty assigned to the management air areas.

At Step S12, the flight plan generation portion 110 determines whether the local flight route settlement is successful for all the multiple management air areas settled at Step S10. If Step S10 settles the management air areas assigned “high” flight route settlement difficulty, the local flight route settlement is highly unlikely to succeed in all the management air areas. If Step S10 settles the management air areas only assigned “low” flight route settlement difficulty, the local flight route settlement is highly likely to succeed in all the management air areas. When the local flight route settlement is successful in all the management air areas, the flight plan generation portion 110 terminates the process related to the flight route settlement. At the point when the local flight route settlement is determined to be unsuccessful in any of the management air areas, the flight plan generation portion 110 aborts the local flight route settlement and proceeds to Step S13.

At Step S13, the flight plan generation portion 110 determines whether the scheduled arrival time is prioritized over the route length, for example, during the flight mission of the flight vehicle 200. If the scheduled arrival time is prioritized, the flight plan generation portion 110 proceeds to Step S30. If the scheduled arrival time is not prioritized, the flight plan generation portion 110 proceeds to Step S20.

At Step S20, the flight plan generation portion 110 postpones the scheduled departure time of the flight vehicle 200 until the flight route settlement difficulty of the management air areas, settled at Step S10, is alleviated. For example, the flight plan generation portion 110 postpones the scheduled departure time of the flight vehicle 200 until the “high” flight route settlement difficulty assigned to at least one of the multiple management air areas settled at Step S10 changes to “low” or “medium.”

Namely, suppose the management air area assigned with the flight route settlement difficulty higher than or equal to a standard is included in the management air areas through which the flight vehicle 200 flies the shortest route from the departure place to the arrival place. Then, the flight plan generation portion 110 delays the departure of the flight vehicle 200 until the flight route settlement difficulty of such management air area falls below the standard.

The operation management device 100 can fly the flight vehicle 200 from the departure place to the arrival place via the shortest route while reducing the failure probability of the local flight route settlement, thereby maximizing the energy efficiency of the flight vehicle 200. The operation management device 100 can suppress the energy consumption of the flight vehicle 200 while efficiently settling the flight route across the multiple management air areas.

At Step S21, the flight plan generation portion 110 performs the global flight route settlement (1) to settle multiple management air areas through which the flight vehicle 200 passes when flying the shortest route from the departure place to the arrival place.

At Step S22, the flight plan generation portion 110 performs the local flight route settlement to settle the flight route within the management air area in descending order of the flight route settlement difficulties of the management air areas settled at Step S21.

At Step S23, the flight plan generation portion 110 determines whether the local flight route settlement is successful for all the multiple management air areas settled at Step S21. When the local flight route settlement is successful in all the management air areas, the flight plan generation portion 110 terminates the process related to the flight route settlement. At the point when the local flight route settlement is determined to be unsuccessful in any of the management air areas, the flight plan generation portion 110 aborts the local flight route settlement and proceeds to Step S20.

At Step S30, the flight plan generation portion 110 performs the global flight route settlement (2) to settle the go-through management air area by bypassing the management air area assigned a high flight route settlement difficulty included in the management air areas settled at Step S10 and making a detour to the management air area assigned the low flight route settlement difficulty. For example, the flight plan generation portion 110 settles the go-through management air area by bypassing the management air area assigned the “high” difficulty included in the management air areas settled at Step S10 and making a detour to the management air area that is close to such management air area and is assigned the “low” or “medium” flight route settlement difficulty.

Namely, suppose the management air area assigned the flight route settlement difficulty higher than or equal to a standard is included in the management air areas through which the flight vehicle 200 flies the shortest route from the departure place to the arrival place. Then, the flight plan generation portion 110 bypasses such management air area and settles multiple management air areas through which the flight vehicle 200 passes when flying from the departure place to the arrival place.

The operation management device 100 can operate the flight vehicle 200 without delaying its departure while reducing the probability of failure in the local flight route settlement, thereby minimizing delays in the arrival of the flight vehicle 200. Furthermore, the operation management device 100 can prevent flight routes from concentrating in a specific management air area. The operation management device 100 can inhibit the flight vehicle 200′s operation schedule from being disrupted and increase the utilization efficiency of the entire air area while efficiently settling the flight route across the multiple management air areas.

At Step S31, the flight plan generation portion 110 performs the local flight route settlement to settle the flight route within the management air area in descending order of the flight route settlement difficulties of the management air areas settled at Step S30.

At Step S32, the flight plan generation portion 110 determines whether the local flight route settlement is successful for all the multiple management air areas settled at Step S30. When the local flight route settlement is successful in all the management air areas, the flight plan generation portion 110 terminates the process related to the flight route settlement. At the point when the local flight route settlement is determined to be unsuccessful in any of the management air areas, the flight plan generation portion 110 aborts the local flight route settlement and proceeds to Step S30.

When the process related to the flight route settlement is performed, the management air area may indicate an obviously high flight route settlement difficulty and disable the flight route settlement. In such a case, the flight plan generation portion 110 may start the process related to the flight route settlement from Step S13 as illustrated in FIG. 15 without performing Steps S10 through S12.

The local flight route settlement may be unsuccessful even after attempting the global flight route settlement (2) at Step S30 a predetermined number of times or more. In such a case, the flight plan generation portion 110 may postpone the scheduled departure time of the flight vehicle 200 and perform the global flight route settlement (1) and the local flight route settlement as illustrated at Steps S34 through S36 in FIG. 16. Steps S34 through S36 in FIG. 16 are equal to Steps S20 through S22.

At Step S37 in FIG. 16, the flight plan generation portion 110 determines whether the local flight route settlement is successful for all the multiple management air areas settled at Step S35. When the local flight route settlement is successful in all the management air areas, the flight plan generation portion 110 terminates the process related to the flight route settlement. At the point when the local flight route settlement is determined to be unsuccessful in any of the management air areas, the flight plan generation portion 110 aborts the local flight route settlement and proceeds to Step S30.

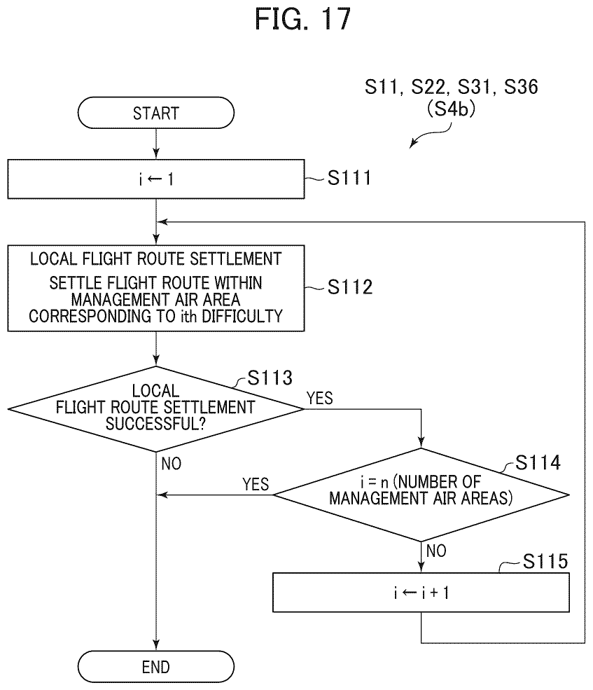

FIG. 17 is a flowchart illustrating the algorithm of processes related to the local flight route determination illustrated in FIGS. 14 through 16.

The flowchart illustrated in FIG. 17 is performed at Steps S11, S22, S31, and S36 in FIGS. 14 through 16.

At Step S111, the flight plan generation portion 110 assigns 1 to the index i of the management air area to initialize it.

At Step S112, the flight plan generation portion 110 performs the local flight route settlement to settle the flight route within the management air area assigned with the ith difficulty.

At Step S113, the flight plan generation portion 110 determines whether the local flight route settlement at Step S112 is successful. If the local flight route settlement at Step S112 is successful, the flight plan generation portion 110 proceeds to Step S114. If the local flight route settlement at Step S112 is unsuccessful, the flight plan generation portion 110 aborts and terminates the process related to the local flight route settlement in FIG. 17.

At Step S114, the flight plan generation portion 110 determines whether the management air area index i equals n (the number of management air areas). If the management air area index i equals n (the number of management air areas), the local flight route settlement is successful in all the management air areas settled in the global flight route settlement. Then, the flight plan generation portion 110 terminates the process related to the local flight route settlement illustrated in FIG. 17. If the management air area index i does not equal n (the number of management air areas), the flight plan generation portion 110 proceeds to Step S115.

At Step S115, the flight plan generation portion 110 increments the index i of the management air area and proceeds to Step S112.

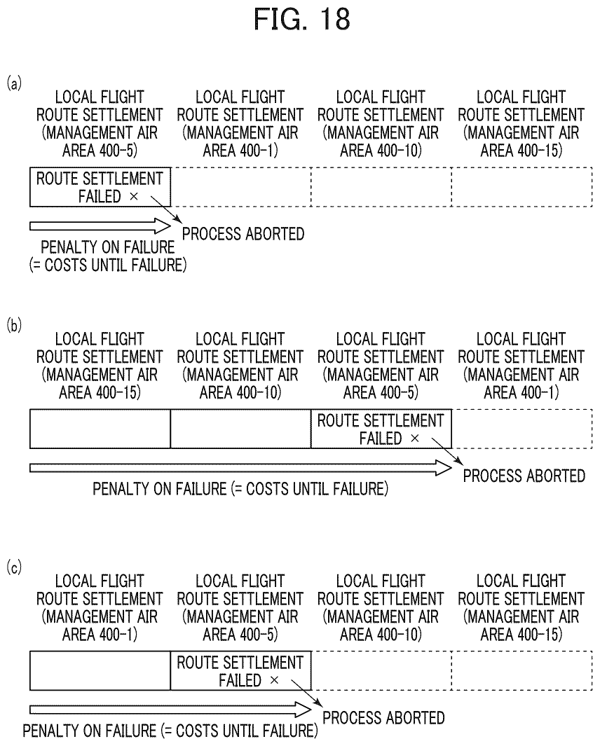

The local flight route settlement (Steps S11, S22, S31, and S36) settles flight routes in the management air areas in descending order of flight route settlement difficulties, beginning with the management air area assigned the highest flight route settlement difficulty. This is because it is possible to minimize the penalty (costs spent until a failure) when the local flight route settlement fails, as illustrated in FIG. 18.

FIG. 18 is a diagram illustrating penalties when the local flight route settlement fails. FIG. 18 (a) is a diagram illustrating the penalty for the local flight route settlement performed in descending order of flight route settlement difficulties, beginning with the management air area assigned the highest flight route settlement difficulty. FIG. 18 (b) is a diagram illustrating the penalty for the local flight route settlement performed in descending order of flight route settlement difficulties, beginning with the management air area near the arrival place. FIG. 18 (c) is a diagram illustrating the penalty for the local flight route settlement performed in descending order of flight route settlement difficulties, beginning with the management air area near the departure place.

Based on the comparison among FIG. 18 (a) through 18 (c), the case of FIG. 18 (a) incurs the cost, such as the amount of calculation or calculation time, of the local flight route settlement only for the management air area 400-5 until the local flight route settlement for the management air area 400-5 fails and the process is aborted. The case of FIG. 18 (b) incurs the cost, such as the amount of calculation or calculation time, of the local flight route settlement for the management air areas 400-5, 400-10, and 400-15 until the local flight route settlement for the management air area 400-5 fails and the process is aborted. The case of FIG. 18 (c) incurs the cost, such as the amount of calculation or calculation time, of the local flight route settlement for the management air areas 400-5 and 400-1 until the local flight route settlement for the management air area 400-5 fails and the process is aborted.

For these reasons, the operation management device 100 settles the flight routes (local flight route settlement) in the management air areas in descending order of flight route settlement difficulties beginning with the management air area assigned the highest flight route settlement difficulty out of the management air areas (settled in the global flight route settlement) through which the flight vehicle 200 passes when flying from the departure place to the arrival place.

The operation management device 100 can minimize the penalty for a failure in the local flight route settlement and minimize the amount of calculation or calculation time lost until the failure. Consequently, the operation management device 100 can efficiently settle the flight route across the multiple management air areas.

The management air areas settled in the global flight route settlement may include the management air area whose flight route settlement difficulty is unknown. In such a case, the operation management device 100 settles the flight routes in the management air areas in the order of the management air area assigned an unknown flight route settlement difficulty, the management air area assigned the “medium” flight route settlement difficulty, and the management air area assigned the “low” flight route settlement difficulty (local flight route settlement).

The operation management device 100 can perform the local flight route settlement preferentially from the management air area whose flight route settlement difficulty is unknown, to possibly cause a failure in the local flight route settlement, thus minimizing the penalty for a failure in the local flight route settlement. The operation management device 100 can efficiently settle the flight route across the multiple management air areas, even if there is the management air area whose flight route settlement difficulty is unknown.

### Eighth Embodiment

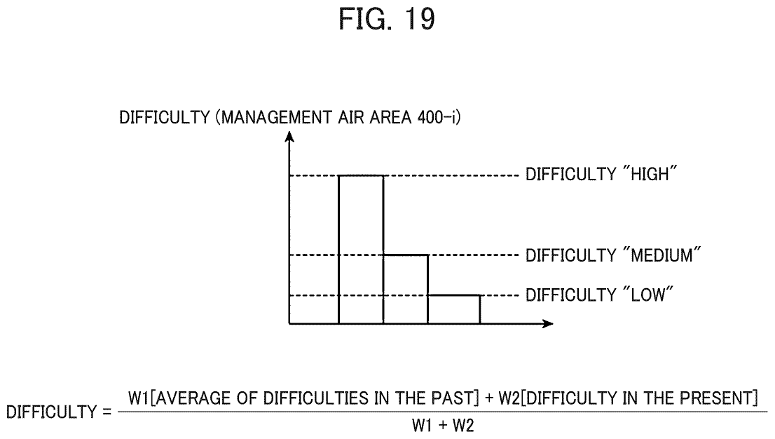

The seventh embodiment explains the flight route settlement difficulty. FIG. 19 is a diagram illustrating the flight route settlement difficulties.

As illustrated in FIG. 19, the flight route settlement difficulty is set for each management air area. The flight route settlement difficulty is set for each scheduled time of passage of the flight vehicle 200 in each management air area. The flight route settlement difficulty is set to “low” if the flight route within the management air area can be settled as the shortest route at the corresponding time. The flight route settlement difficulty is set to “medium” if the flight route within the management air area can be settled as the bypass route, not the shortest route, at the corresponding time. The flight route settlement difficulty is set to “high” if the flight route within the management air area cannot be settled even as the bypass route, at the corresponding time.

The operation management device 100 sets the flight route settlement difficulty by calculating an index representing the likelihood of success or failure in the flight route settlement for each scheduled time of passage of the flight vehicle 200 in each management air area. For example, the operation management device 100 can set the flight route settlement difficulty based on the number of failures in settling the flight route within the management air area or the presence or absence of a failure. In other words, the operation management device 100 can set the flight route settlement difficulty based on past results of the local flight route settlement.

The operation management device 100 can allow the flight route settlement difficulties to appropriately reflect the possibility of failing to settle the flight route within the management air area. It is possible to reduce the probability of failure in the local flight route settlement and minimize the penalty for a failure in the local flight route settlement. Consequently, the operation management device 100 can efficiently settle the flight route across the multiple management air areas.

For example, the operation management device 100 can set the flight route settlement difficulty based on the number of flight vehicles 200 requesting to fly in the management air area.

The operation management device 100 can allow the flight route settlement difficulties to appropriately reflect the congestion situation of the management air area at the corresponding time. It is possible to reduce the probability of failure in the local flight route settlement and minimize the penalty for a failure in the local flight route settlement. Consequently, the operation management device 100 can efficiently settle the flight route across the multiple management air areas.

For example, the operation management device 100 can set the flight route settlement difficulty based on the level (restriction level) to restrict flights in the management air area.

The operation management device 100 can allow the flight route settlement difficulties to appropriately reflect the flight restriction situation in the management air area. It is possible to reduce the probability of failure in the local flight route settlement and minimize the penalty for a failure in the local flight route settlement. Consequently, the operation management device 100 can efficiently settle the flight route across the multiple management air areas.

For example, the operation management device 100 can set the flight route settlement difficulty based on a weighted average between the past flight route settlement difficulty and the current flight route settlement difficulty. Specifically, the operation management device 100 can calculate the flight route settlement difficulty by using the following equation. In the equation, W1 and W2 denote weighting coefficients. [Average of past difficulties] indicates the characteristics specific to the management air area, such as including many important facilities that must be bypassed.

$$[ Flight route settlement difficulty ] = ( ( W 1 \times [ average of past difficulties ] + W 2 \times [ current difficulty ] ) / ( W 1 + W 2 )$$

The operation management device 100 can allow the flight route settlement difficulties to appropriately reflect the characteristics specific to the management air area. It is possible to reduce the probability of failure in the local flight route settlement and minimize the penalty for a failure in the local flight route settlement. Consequently, the operation management device 100 can efficiently settle the flight route across the multiple management air areas.

For example, an event comparable to the “medium” difficulty may occur repeatedly in the management air area that is assigned the “medium” difficulty under the control of the local flight route settlement. In such a case, the operation management device 100 can increment an index representing the flight route settlement difficulty and, when the index reaches a standard or higher, change the flight route settlement difficulty of the management air area to “high.”

The operation management device 100 can bypass not only the management air area assigned the “high” difficulty but also the management air area where an event comparable to the “medium” difficulty occurs frequently, during the process of the global flight route settlement. It is possible to reduce the probability of failure in the local flight route settlement. The operation management device 100 can efficiently settle the flight route across the multiple management air areas and inhibit flight routes from concentrating in a specific management air area to further increase the utilization efficiency of the entire air area.

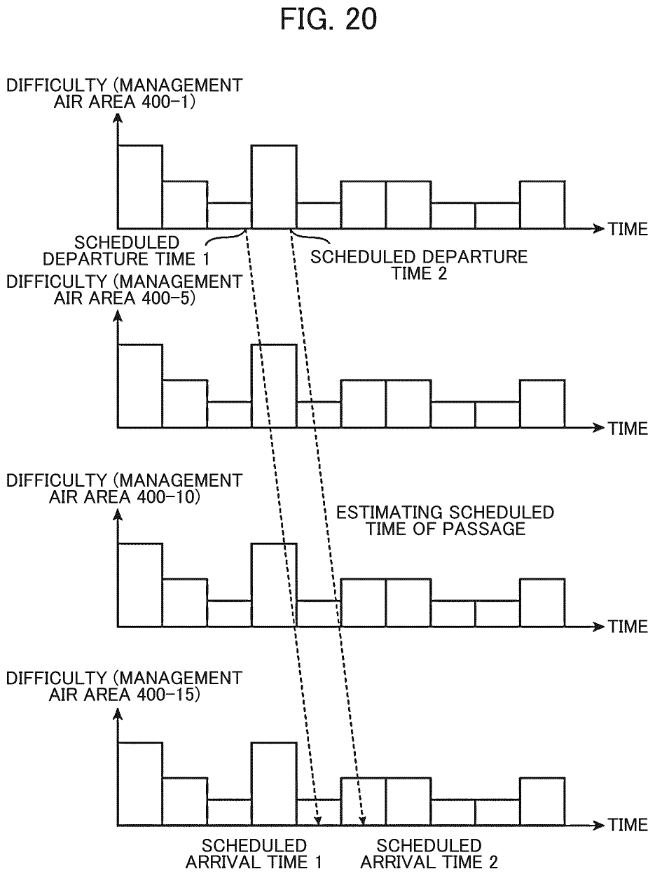

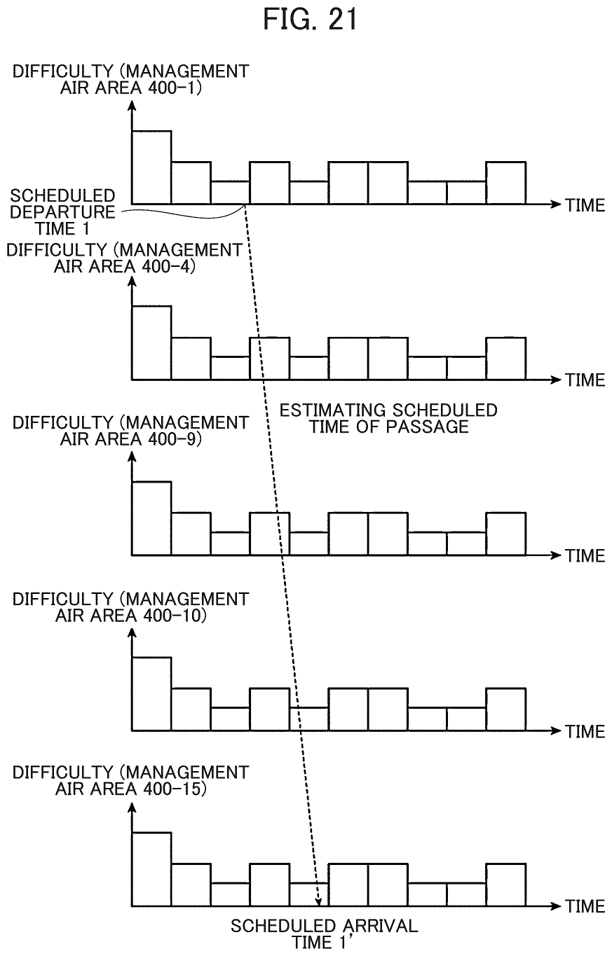

FIG. 20 is a diagram illustrating global flight route settlement based on the flight route settlement difficulties illustrated in FIG. 19. FIG. 21 is a diagram illustrating global flight route settlement based on the flight route settlement difficulties illustrated in FIG. 19.

The vertical axes in FIGS. 20 and 21 show the flight route settlement difficulty of each management air area. The horizontal axes in FIGS. 20 and 21 show the time (scheduled time of passage). FIGS. 20 and 21 illustrate the flight route settlement difficulty at each time as bar graphs.

FIG. 20 illustrates the flight route settlement difficulties of the management air areas 400-1, 400-5, 400-10, and 400-15 on the shortest route from the departure place A to the arrival place B. FIG. 20 illustrates that the flight vehicle 200 leaves the departure place A at a scheduled departure time 1 and arrives at the arrival place B at a scheduled arrival time 1. In this case, the management air area 400-5 is assigned the “high” flight route settlement difficulty. The local flight route settlement is highly likely to fail in the management air area 400-5. Therefore, the operation management device 100 delays the departure of the flight vehicle 200 until the flight route settlement difficulty in the management air area 400-5 changes to “low” or “medium.” For example, the operation management device 100 postpones the scheduled departure time 1 to a scheduled departure time 2. The flight vehicle 200 that departs from the departure place A at the scheduled departure time 2 will arrive at the arrival place B at a scheduled arrival time 2.

FIG. 21 illustrates the flight route settlement difficulties of the management air areas 400-1, 400-4, 400-9, 400-10, and 400-15 on a route that bypasses the management air area 400-5 assigned the “high” flight route settlement difficulty. The “medium” or “low” flight route settlement difficulty is assigned to each of the management air areas 400-1, 400-4, 400-9, 400-10, and 400-15 on the flight route bypassing the management air area 400-5 at the corresponding scheduled time of passage. Therefore, the operation management device 100 settles the flight route that bypasses the management air area 400-5 assigned the “high” flight route settlement difficulty and passes through the management air areas 400-1, 400-4, 400-9, 400-10, and 400-15. The flight vehicle 200 that departs from the departure place A at the scheduled departure time 1 will arrive at the arrival place B at scheduled arrival time 1′.

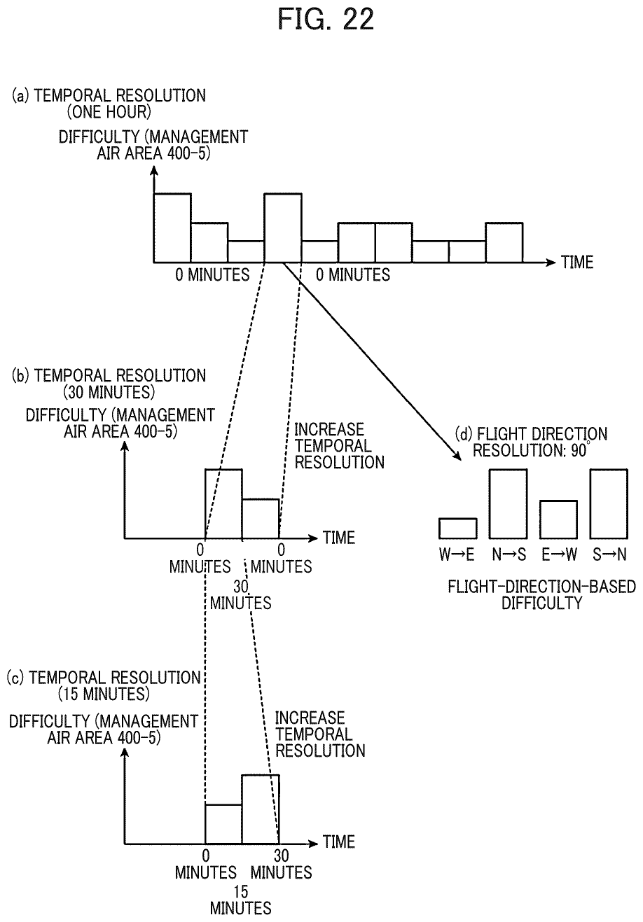

FIG. 22 is a diagram illustrating the flight route settlement difficulties.

As illustrated in FIG. 22, the operation management device 100 can increase the temporal resolution or flight direction resolution of the flight route settlement difficulty for the management air area assigned the “high” difficulty and distinguish between the time window or flight direction corresponding to the “high” difficulty and the time window or flight direction not corresponding to the “high” difficulty.

As illustrated in FIG. 22 (a), the management air area 400-5 includes a time window (at a temporal resolution of hours, for example) assigned the “high” difficulty. In this case, the operation management device 100 increases the temporal resolution (such as temporal resolution of 30 minutes) as illustrated in FIG. 22 (b). In the example of FIG. 22 (b), the time window from 0 to 30 minutes is assigned the “high” difficulty. The time window from 30 to 0 minutes is assigned the “medium” difficulty. Then, as illustrated in FIG. 22 (c), the operation management device 100 increases the temporal resolution of the time window from 0 minutes to 30 minutes, assigned the “high” difficulty (to the temporal resolution of 15 minutes, for example). As illustrated in FIG. 22 (c), it can be seen that the time window from 15 to 30 minutes is assigned the “high” difficulty, and the time window from 0 to 15 minutes is assigned the “medium” difficulty. The operation management device 100 just needs to delay the scheduled departure time of the flight vehicle 200 so as not to pass through the management air area 400-5 during the time window from 15 to 30 minutes assigned the “high” difficulty. It is possible to minimize delays in the arrival of the flight vehicle 200.

As illustrated in FIG. 22 (d), the operation management device 100 may increase the flight direction resolution of the flight vehicle 200 in the management air area 400-5. As illustrated in FIG. 22 (d), the directions from south to north and from north to south are assigned the “high” difficulty. The direction from east to west is assigned the “medium” difficulty. The direction from west to east is assigned the “low” difficulty. The operation management device 100 can settle the flight route directed east and west in the management air area 400-5 without needing to completely bypass the management air area 400-5. It is possible to minimize an increase in the path length of the flight

As illustrated in FIG. 6, the management air area assigned the “high” difficulty is divided into management air areas 400-3-1 through 400-3-m according to altitudes. In this case, the operation management device 100 may assign the “high” difficulty to different flight directions in each of the management air areas divided according to altitudes. Even in this case, the operation management device 100 can increase the flight direction resolution in each of the management air areas divided according to altitudes.

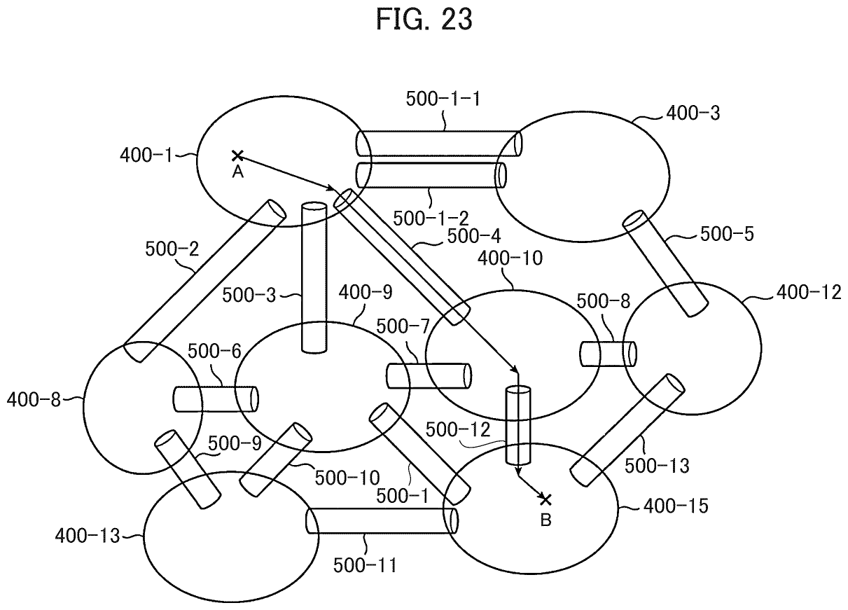

FIG. 23 is a diagram illustrating an example in which the management air areas are not located closely.

FIG. 23 illustrates that the management air areas are not closely located. Even in this case, the operation management device 100 can settle the flight route of the flight vehicle 200 by connecting the management air areas with corridors. There may be a large amount of traffic between the management air areas 400-1 and 400-3. In this case, the operation management device 100 can connect the management air areas by using multiple corridors, such as corridors 500-1-1 and 500-1-2.

The first through eighth embodiments above have explained the operation management device 100 that settles the flight routes of the flight vehicle 200 flying in the air as a 3D space. The operation management device 100 can also be applied to the settlement of migration paths for various mobile objects, including submersibles such as AUVs (Autonomous Underwater Vehicles) navigating underwater in 3D space, or vehicles, robots, and ships moving in 2D space.

### Others

It should be noted that the present invention is not limited to the embodiments described above, and includes various modifications. For example, the embodiments described above have been described in detail to simply describe the present invention, and are not necessarily required to include all the described configurations. In addition, part of the configuration of one embodiment can be replaced with the configurations of other embodiments, and, the configuration of the one embodiment can also be added with the configurations of other embodiments. In addition, part of the configuration of each of the embodiments can be subjected to addition, deletion, and replacement with respect to other configurations.

The above-described configurations, functions, processing portions, and processing means, for example, may be embodied as hardware by designing all or part thereof as integrated circuits, for example. The above-described configurations and functions, for example, may be embodied as software by allowing the processor to interpret and execute a program that embodies each function. Information such as programs, tables, or files to embody each function can be stored in storage devices such as memory, hard disk, and SSD (Solid State Drive) or in recording media such as IC (Integrated Circuit) card, SD (Secure Digital) card, and DVD (Digital Versatile Disc).

Control lines and information lines are illustrated as necessary for explanation and do not completely show all control lines and information lines needed for the product. It may be favorable to consider that almost all configurations are interconnected practically.

### LIST OF REFERENCE SIGNS

100: operation management device, 200: flight vehicle, 300: flight route settlement difficulty, 400-i: management air area

1. An operation management device that performs operation management of a flight vehicle flying across a plurality of management air areas,
wherein the operation management device centrally manages the management air areas;
wherein the operation management device assigns each of the management air areas with a flight route settlement difficulty indicating the difficulty of settling a flight route within the management air area; and
wherein the operation management device settles a flight route across the management air areas based on the acquired flight route settlement difficulty.

2. The operation management device according to claim 1,
wherein the operation management device settles the management air areas through which the flight vehicle passes when flying from a departure place to an arrival place, based on the flight route settlement difficulty; and
wherein the operation management device settles a flight route within each of the settled management air areas.

3. The operation management device according to claim 2,
wherein a flight route is settled within the management air areas in descending order of flight route settlement difficulties beginning with the management air area assigned the highest flight route settlement difficulty out of the management air areas through which the flight vehicle passes when flying from a departure place to an arrival place.

4. The operation management device according to claim 2,
wherein, when the management air area assigned the flight route settlement difficulty higher than or equal to a standard is included in the management air areas through which the flight vehicle flies the shortest route from a departure place to an arrival place, the departure of the flight vehicle is delayed until the flight route settlement difficulty of such management air area falls below the standard.

5. The operation management device described in claim 2,
wherein, when the management air area assigned the flight route settlement difficulty higher than or equal to a standard is included in the management air areas through which the flight vehicle flies the shortest route from a departure place to an arrival place, the operation management device bypasses such management air area and settles the management air areas through which the flight vehicle passes when flying from a departure place to an arrival place.

6. The operation management device according to claim 1,
wherein the flight route settlement difficulty is set based on the number of the flight vehicles requesting to fly within the management air area.

7. The operation management device according to claim 1, wherein the flight route settlement difficulty is set based on a level of restricting flight within the management air area.

8. The operation management device according to claim 1,
wherein the flight route settlement difficulty is set based on the number of failures in settling a flight route within the management air area or the presence or absence of a failure.

9. The operation management device according to claim 1,
wherein the flight route settlement difficulty is set based on a weighted average between the past flight route settlement difficulty and the current flight route settlement difficulty.

10. The operation management device according to claim 1,
wherein the flight route settlement difficulty includes “low” difficulty capable of settling a flight route within the management air area as the shortest route, “medium” difficulty capable of settling a flight route within the management air area as a bypass route, not the shortest route, and “high” difficulty incapable of settling a flight route within the management air area even as the bypass route; and
wherein, when an event comparable to the “medium” difficulty occurs repeatedly in the management air area, the flight route settlement difficulty of such management air area is changed to “high.”
